(19) United States
(12) Patent Application Publication
(10) Pub. No.: US 2001/0025242 A1
(43) Pub. Date: Sep. 27, 2001

(54) Error concealment method with pitch change detection

(76) Inventor: Yann Joncour, Le Mans (FR)

Correspondence Address: Corporate Patent Counsel, U.S. Philips Corporation, 580 White Plains Road, Tarrytown, NY, 10591, US

(21) Appl. No.: 09/778,278

(22) Filed: Feb. 7, 2001

(30) Foreign Application Priority Data
Feb. 10, 2000 (EP) 00400396.8

(51) Int. Cl. G10L 15/08; G10L 15/12; G10L 15/00

(52) U.S. Cl. 704/240

(57) ABSTRACT

An error concealment method is for improving the speech signal quality at the receiving end in speech transmission systems is described particularly, it relates to a method of receiving speech signals which have been encoded through speech parameters before transmission via a transmission channel, the method comprising an error detection step, using parameter statistics, of detecting corrupted parameters among received parameters and a speech decoding step of decoding the received parameters and retrieving the transmitted speech signal. Depending on the calculation process performed by the speech coder for generating the speech parameters, a pitch doubling/halving of the parameter values may occur during speech parameter coding. Although this phenomenon has no consequence for the received signal quality, it may cause a misdetection by error concealment methods using parameter statistics. According to the invention, the error detection step performs a pitch doubling/halving detection to verify if received speech parameters, which occur to have a value within a range relatively far beyond previous received parameters, are really corrupted, or if this different range simply results from a pitch doubling/halving of the parameter values produced during speech parameter coding.

The invention relates to error concealment in speech transmission systems for improving the speech signal quality at the receiving end. More particularly, it relates to a method of processing an encoded speech signal comprising speech parameters, the method comprising an error detection step of detecting probably corrupted speech parameters.

The invention has numerous applications, in particular in transmission systems which are submitted to adverse channel conditions. Moreover, the invention is compatible with the GSM (Global System for Mobile telecommunications) full-rate speech codec and channel codec.

The article by Norbert Gortz “On the Combination of Redundant and Zero-Redundant Channel Error Detection in CELP Speech Coding” published in EUPSICO-98, pages 721-724, September 1998, describes an error concealment method of correcting, at the receiving end, only corrupted speech parameters within bad frames. According to this method, a channel decoder indicates whether a frame is to be considered as bad or not by means of a flag. The method exploits parameter statistics in order to detect and correct the corrupted speech parameters within bad frames. The parameter statistics are determined by the cumulative distribution function of an inter-frame difference, or an inter-sub-frame difference, between the received speech parameters. Large absolute values for the inter-frame, or inter-sub-frame, difference are considered as highly improbable. Therefore, a parameter whose value causes a relatively large inter-frame, or inter-sub-frame, difference is considered as corrupted and will therefore not be used for speech decoding.

It is an object of the present invention to provide an error concealment method which yields a better audio quality of the speech signal at the receiving end.

The invention takes the following aspects into consideration. In limited bandwidth transmission systems, such as the GSM system, for example, speech parameters are transmitted through a transmission channel instead of the full speech signal in order to reduce the transmission bit rate. The speech parameters are derived from a genuine speech signal by a speech encoder in the following manner. The input speech signal is divided into speech frames of, for example, 20 milliseconds. The speech encoder then encodes the 20 ms speech frames into a set of speech parameters (76 in the case of the GSM full-rate speech codec). The consecutive set of speech parameters forms a stream of information data bits.

According to the speech characteristic features, serious changes in subsequent frames of a speech signal are highly improbable. Consequently, serious changes in the subsequent speech parameters values to be transmitted which are derived from the speech signal, are also highly improbable. Therefore, such changes in the speech parameters at the receiving end are also unlikely to occur under ideal channel conditions. Yet, there are some cases, independently of the channel conditions, where changes in subsequent speech parameters should not be considered as abnormal. One of these cases is explained hereafter by means of an example.

The speech parameters are produced by the speech encoder using an appropriate encoding calculation process. Due to the particular encoding algorithm used to encode a particular speech parameter, it may happen that the parameter produced by the speech encoder may have very different values, all of which are correct values. In music theory, it is comparable as if the produced parameter was the note not withstanding the octave. All produced values are generally linked to one of them, denoted the true value, which has a physical meaning corresponding to the real value of the speech parameter. However, as far as further processing is concerned, any one of the possible values is correct.

In the GSM standard, the generation process of at least one of the speech parameters may cause jumps in the produced values. This speech parameter is currently called the LTP Lag parameter and represents the pitch period of the transmitted speech signal. The speech encoding process implemented in the speech encoder for generating this particular speech parameter is susceptible to generating very different values for the pitch period. Actually, these values are a multiple or a divider (by an integer) of the true value. The phenomenon is often referred to as the pitch doubling/halving phenomenon. It occurs, for example, when the speech encoder determines a pitch period parameter which is twice larger or smaller than the true parameter value.

Although this phenomenon has no consequence for the speech signal quality, it may cause a misdetection of errors by error concealment methods using statistics on speech parameters. Actually, since big changes in the received speech parameters values are improbable, except for the cited phenomenon, statistic error detection methods, such as the cited error concealment method, would detect an error on the speech parameter while the parameter is correct but, has encountered a pitch jump during its encoding process.

An error concealment method according to the invention is provided to prevent such a pitch change in the transmitted parameters from causing a misdetection of error.

In accordance with the invention, a method, a computer program product for carrying out the method, a receiver and a radio telephone comprising a receiver wherein the computer program product can be imbedded, is provided which removes the cited drawbacks of the known method. In this respect, a method as mentioned in the opening paragraph is provided wherein the error detection step comprises a classification step of assigning the speech parameters to at least a parameter-value range, denoted area (Area s), among a plurality of parameter-value ranges, and for performing the error detection on the basis of statistics on speech parameters which have been previously assigned to the same area.

The method performs a classification of the received parameters in areas, corresponding to the ranges taken by the parameter values. Then the method uses the parameter statistics on a range-by-range basis in order to force the statistics to be made on the basis of parameters received in the same range. This prevents detection of large differences between received parameters, due to the pitch jumping phenomenon mentioned herein before.

According to a preferred embodiment, in which the speech parameters are processed subsequently and the parameter under processing is denoted the current parameter, the classification step comprises a border value calculation step of calculating an average value of the parameters which determines a border value between a lower and a higher area and of supplying an area indicator indicating to which area the current parameter belongs. The space of values taken by the speech parameters is split into at least 2 areas, one of which contains the received parameter value.

According to the preferred embodiment, the error detection step comprises a comparison step of comparing the current parameter value with a function of at least one previous parameter belonging to the same area as the area indicated by the area indicator and detected as being uncorrupted, and of supplying a corruption indicator indicating if the current parameter may be corrupted. An inter-sub-frame difference is defined as the difference between the parameter under processing which is located within a certain area and a statistic value depending on previously processed parameters located in the same area and detected as being uncorrupted. When the absolute value of the inter-sub-frame difference, or the inter-frame difference, is too large, the parameter under processing is declared to be probably corrupted.

The invention provides the advantage of removing or at least reducing the perception of loud clicks caused by channel errors in the speech signal. It also contributes to improving the intelligibility of the speech signal listened to by an end user.

The invention and additional features, which may be optionally used to implement the invention to advantage, are apparent from and will be elucidated with reference to the drawings described hereinafter.

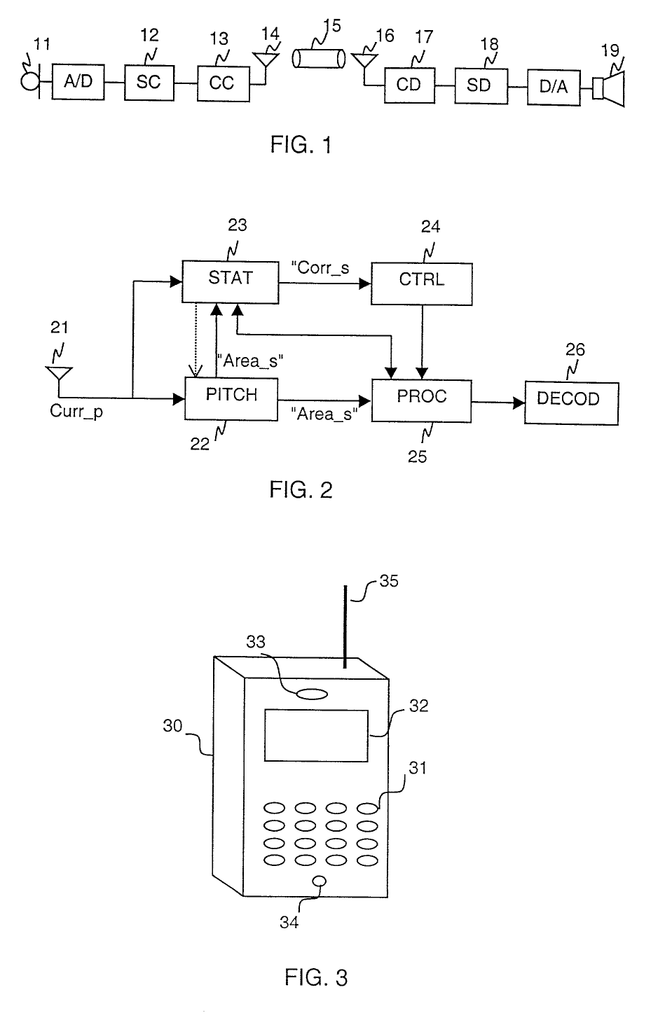

FIG. 1 is a schematic diagram illustrating an example of a basic transmission system comprising a receiver according to the invention.

FIG. 2 is a block diagram representing a preferred embodiment of a receiver according to the invention.

FIG. 3 shows an example of a radio telephone according to the invention.

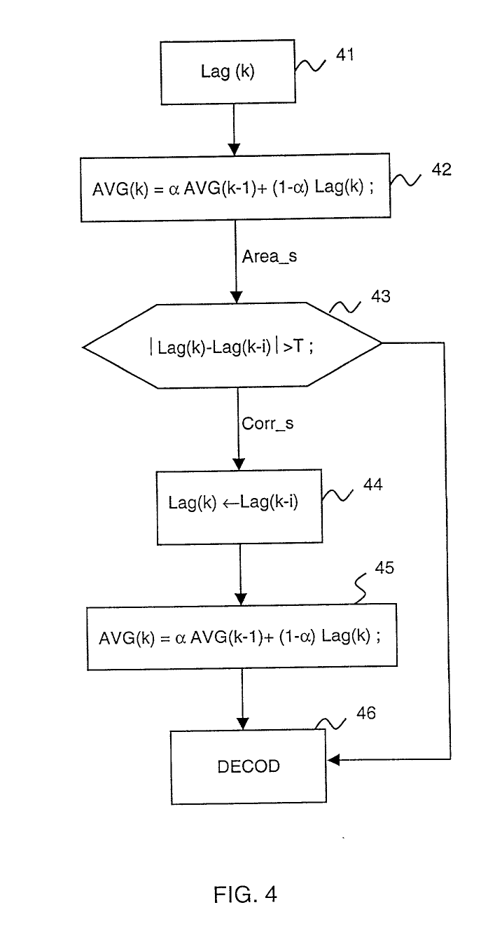

FIG. 4 is a flow chart for illustrating a method according to the invention.

FIG. 1 illustrates an example of a voice transmission system, operating in accordance with a communication standard such as the GSM recommendation, in which a receiver according to the invention may be implemented. Some reference numerals, used as mere examples for improving the comprehension of the invention, relate to the GSM standard. The invention could be implemented in any other communication standard without prejudice. The system of FIG. 1 comprises a transmitting part including blocks 11, 12 and 13 and a receiving part including blocks 17, 18 and 19. The system comprises:

a microphone 111 for receiving a voice signal and for converting it into an analog electric speech signal,

an analog-to-digital converter A/D for converting the analog speech signal received from the microphone 11 into digital speech samples,

a speech encoder SC 12 for segmenting the input speech samples into speech frames, of, for example, 20 milliseconds and for encoding the speech frames into a set of, for example, 76 speech parameters

a channel encoder CC 13 for protecting the speech parameters from transmission errors due to the channel,

a transmitting circuit 14 for sending the speech parameter through the transmission channel,

a transmission channel 15, for example a radio channel,

a reception circuit 16 for receiving the speech parameters from the transmission channel,

a channel decoder CD 17 for removing the redundancy bits added by the channel encoder 13 and for retrieving the transmitted speech parameters,

a speech decoder SD 18 for decoding the speech parameters received from the channel decoder 17 and generated by the speech encoder 12 and for retrieving the transmitted speech signal,

a digital-to-analog converter D/A, for converting the digital speech signal received from the speech decoder 18 into an analog speech signal,

a speaker or ear piece 19 for supplying an audio speech message to a user.

A speech encoder and decoder 12 and 18, respectively, described in the GSM recommendation 06.10 (ETS 300 961): “Digital cellular telecommunication system; Full rate speech; transcoding” May 1997, as one and the other part of the GSM full-rate speech codec. The aim of the speech codec is to reduce the transmission bit rate. A channel encoder and decoder 13 and 17, respectively, is described in the GSM recommendation 05.03 (ETS 300 909): “Digital cellular telecommunication system (phase 2+); Channel coding; ” August 1996 as one and the other part of the GSM channel codec. The aim of the channel codec is to add redundancy to the transmitted information bits which form the speech parameters in order to protect them against channel errors.

As a matter of fact, adverse channel conditions may cause the speech parameters received by the reception circuit 16 to comprise numerous data errors. The channel encoder 13 has for its object to protect the transmitted data against such channel errors. However, under extreme channel conditions, data errors may still remain besides channel coding. Error concealment procedures are thus provided to cope with remaining errors due to the channel in order to better prepare the further speech decoding process and improve the final speech quality.

An error concealment device and method according to the invention will be described hereinafter with reference to FIGS. 2 to 4. Such a device and method can be implemented in any one of the channel decoding or speech decoding block. It can also be implemented in a separate entity placed between the channel and speech decoding blocks.

FIG. 2 illustrates an example of a receiver according to the invention for receiving an encoded speech signal comprising speech parameters. The receiver comprises an error detection device 22, 23 for detecting corrupted speech parameters. The error detection device comprises a classification unit 22 for assigning the speech parameters to at least a parameter-value range, denoted area, among a plurality of parameter-value ranges, and for performing the error detection on the basis of statistics on speech parameters which have been previously assigned to the same area. An example of such a device is shown in FIG. 2. It comprises:

a receiving circuit 21 for receiving speech parameters, for example, from the channel decoder 17 as shown in FIG. 1,

a classification unit PITCH 22,

a statistic unit STAT 23 for performing statistics about the received speech parameters,

a control unit CTRL 24 and

a processing unit PROC 25 for supplying uncorrupted speech parameters to, for example,

a speech decoding unit DECOD 26.

The receiver as described in FIG. 2 is intended to process one single specific speech parameter. The speech parameters are subsequently received by the receiving circuit 21. According to the GSM recommendation, the transmitted speech signal is encoded into a set of 76 different speech parameters by a speech encoder. A pitch jump occurs when the speech encoder determines a speech parameter which is much larger or lower than the expected speech parameter, that is to say the previous speech parameters.

The speech encoder comprises a preprocessing block for receiving an input speech signal S₀ which is segmented into 20 ms frames. The preprocessing block consists of a high-pass filter which removes the offset of the input signal S₀ and of a first-order FIR filter (Finite Impulse Response) which pre-emphasizes the signal. It also comprises a short-term analysis filter for removing redundant information contained in adjacent samples of the preprocessed signal. The short-term analysis filter outputs a short term residual. In parallel, the preprocessed signal is used in an LPC (linear predictive coding) analysis for issuing LPC parameters. Then the short-term residual as analyzed and filtered by an LTP (long term prediction) analysis and filtering producing LTP parameters: the LTP lag and LTP gain. The output signal is used in a RPE (regular pulse excitation) encoding which also generates speech parameters.

For example, the specific speech parameter processed by the receiver may be the LTP lag parameter as described in the recommendation ETS 300 961. The LTP lag parameter represents the time period of the short-term residual of the speech signal, also called the pitch period, which is quasi-periodic during voice segments. The LTP Lag parameter is obtained by calculating the auto-correlation function of the input speech signal at an instant, denoted t, with the same speech signal delayed, at the instant t+τ, where τ is a positive variable number representing a delay. The LTP Lag or pitch period is the value of the pitch where the auto-correlation function reaches its maximum amplitude. A pitch jump occurs when the speech encoder determines an LTP Lag which is much larger or lower than another correct LTP Lag value situated in an expected range. In the case of the LTP lag parameter, the pitch jump is more particularly a pitch doubling or halving wherein the speech encoder determines an LTP Lag which is twice larger or lower than the expected one. Although this phenomenon has no consequence for the received speech quality, it may cause the speech parameter to be wrongly detected as being corrupted since the error concealment algorithm is based on parameter statistics. This, of course, can significantly degrade the performance of the whole receiving process.

Each currently received speech parameter, denoted the current parameter Curr_p, is sent to the classification unit 22 and to the statistic unit 23. In the statistic unit 23, the parameter Curr_p is provisionally stored for use in statistic calculations. The classification unit 22 splits the space of values taken by the received speech parameters into at least 2 areas within the space of value of the parameters, one of which contains the expected parameter value. These areas are delimited by a border value which can be calculated, for example, using a sliding average of already received parameter values. For an example applying to the GSM full-rate speech codec, the values taken by the LTP lag parameter are in the range [40. . . 120]. This interval is narrow enough to contain only 2 areas, a high area containing the higher values and a low area containing the lower values. The border limit, denoted AVG, between the 2 areas may be calculated as follows, the LTP lags being denoted Lag. The indexes for the current and previous sub-frames are denoted k and k1, respectively. For each new received parameter in a new sub-frame of index k, the sliding average AVG(k) may be calculated by the classification unit 22 as follows:

AVG(k)=α×AVG(k−1)+(1−α)×lag(k) (1)

where α is a coefficient which varies from zero to one. For example, α=0.75. LTP lags lower or equal to the average value AVG(k) are located in the lower area. The LTP lags which are strictly larger than the average value AVG(k) are located in the higher area. Then the classification unit 22 outputs an area indicator “Area_s” indicating to which area the parameter under processing belongs. The area indicator “Area_s” is assigned to a processing unit 24 and to the statistics unit 23.

The statistic unit 23 compares the parameter under processing Curr_p with statistics on the parameters falling in the same area as the one indicated by the area indicator “Area_s”. The difference between the LTP lag under processing Curr_p and previous uncorrupted LTP lags within the same area defines an inter-sub-frame difference. For example, the LTP lag under processing may be compared with a statistic value which is calculated for each new received LTP lags under processing and depends on several previous uncorrupted LTP lag within the same area, each having a certain weight coefficient. A simple solution is to compare the value of the LTP lag under processing with the last received uncorrupted LTP lag within the same area. The statistics unit 23 then calculates the inter-sub-frame difference between the value of the parameter under processing Curr_p and the last received uncorrupted parameter within the same area, denoted Last_p. Then it compares this inter-sub-frame difference with a predetermined reference threshold value. If the inter-sub-frame difference is above the predetermined threshold value, the current parameter Curr_p is then declared as being probably corrupted. For an example, the threshold value may be equal to 13.

The statistic unit 23 outputs a corruption indicator, denoted “Corr_s”, indicating if the current parameter is probably corrupted. The indicator “Corr_s” is received by the control unit 24. Depending on the value of the corruption indicator, the control unit 24 controls a processing unit 25, to save the current parameter Curr_p for further processing (e.g. speech decoding) or to extrapolate the value of the current parameter Curr_p with the value of a previous parameter stored in the statistic unit 23 and located in the same area. For example, the chosen previous parameter may be the last uncorrupted parameter in the same area Last_p. In the case where the current parameter is extrapolated, it is the extrapolated new parameter Last_p which will be used for further processing. When a current parameter detected as probably corrupted is extrapolated, the statistic unit 23 may send a message, represented by a broken-line arrow, to the classification unit 22 to indicate that the current parameter is corrupted. The classification unit 22 should then recalculate the sliding average with the extrapolated parameter Last_p instead of the current parameter Curr_p. This is because the previous sliding average calculated in accordance with equation (1), is erroneous due to the fact that it took a corrupted parameter into account. To avoid propagation of errors in the sliding average calculation, this average should be recalculated with the extrapolated/interpolated parameter value.

At least 2 alternative embodiments may be envisaged. In a first embodiment, the currently received parameter is classified in one of the predetermined areas, depending on its value. Then it is compared with statistic values within the predetermined area to which the current parameter value belongs. The statistic values are based on the values of previously received parameters that were detected as being uncorrupted. In an alternative embodiment, each received value which was detected as being uncorrupted is extrapolated into several areas, corresponding to the areas to which the parameter value would belong if a jump had occurred during the speech parameter coding. According to this embodiment, the statistic device may be provided with more statistic values which would improve their liability. The efficiency of the statistic comparison would then be improved.

FIG. 3 shows a radio telephone according to the invention, comprising a receiver as shown in FIGS. 1 and 2. It comprises a housing 30, a keyboard 31, a screen 32, a speaker 33, a microphone 34 and an antenna 35. The antenna is coupled to a receiving circuit as shown in FIG. 2 by reference numeral 21, and is linked to a receiver as shown in FIGS. 1 and 2.

FIG. 4 illustrates the main steps of a method according to the invention to be carried out by a receiver as shown in FIG. 2. According to a preferred embodiment of the invention, the receiver is controlled by a computer. The computer executes a set of instructions in accordance with a program. When loaded into the receiver, the program causes the receiver to carry out the method as described hereinafter with reference to the blocks 41 to 46.

The method according to the invention is a method of receiving an encoded speech signal comprising speech parameters. The method comprises an error detection step of detecting probably corrupted speech parameters. The error detection step comprises a classification step of assigning the speech parameters to at least a parameter-value range, denoted area, among a plurality of parameter-value ranges. Then the error detection is performed on the basis of statistics on speech parameters which have been previously assigned to the same area.

The received speech signals have been encoded in subsequent frames of data before transmission via a transmission channel. Each frame contains at least a sub-frame comprising speech parameters. For example, one of the speech parameters contained in each sub-frame is the LTP lag parameter, denoted Lag. The currently received LTP lag parameter is denoted Lag(k), the previously received parameter is denoted Lag(k−1).

The method comprises:

a reception step 41 of receiving the current speech parameter, Lag(k),

an error detection step comprising sub-steps 42 to 44, using parameter statistics to detect if the current parameter is corrupted,

a speech decoding step DECOD 46 for decoding the current parameter in order to retrieve the transmitted speech signal.

The error detection step performs a classification prior to a statistic error detection in order to prevent a pitch jump in the transmitted speech parameters from causing a distortion in the statistics and thus a misdetection of channel errors.

Then the error detection step comprises the following sub-steps:

a sliding average calculation step 42,

a comparison step 43,

if the current parameter is detected as being corrupted at the end of the preceding step, a correction step 44 may be performed.

During the sliding average calculation step 42, a sliding average value of received parameters is calculated which determines a border value, denoted AVG(k), between at least a lower and a higher area. The sliding average may be calculated in accordance with equation (1). LTP lags lower or equal to the average value AVG(k) are located in the lower area. The LTP lags which are strictly larger than the average value AVG(k) are located in the higher area. Then an area indicator, denoted Area_s, is supplied to indicate which area the current parameter Lag(k) belongs to.

In the comparison step 43 the current parameter value Lag(k) is compared with the value of a set of at least one previously received parameter belonging to the same area as the one indicated by the area indicator Area_s was detected as being uncorrupted. For example, the current parameter value Lag(k) is compared with the last received parameter located in the same area which was detected as being uncorrupted. This parameter is denoted Lag(k−i), i being a strictly positive integer. If the difference, in absolute value, between the current and the previous parameters values, denoted |Lag(k)−Lag(k−i)| is smaller than a predetermined threshold, denoted T, the method continues with the decoding step 46. If the difference, in absolute value, is larger than the predetermined threshold T, a corruption indicator, denoted Corr_s, is supplied to indicate that the current parameter may be corrupted.

If the corruption indicator Corr_s indicates that the current parameter Lag(k) may be corrupted, a correction step 44 should follow. In this correction step 44, the current speech parameter Lag(k) is extrapolated, that is to say, for example, replaced with a value determined as a function of at least one previously received parameter which was detected as being uncorrupted and which belongs to the same area as the one indicated by the area indicator. Then the method performs a new sliding average calculation step 45, the same as the previous sliding average calculation step 42, for recalculating the border value with the new extrapolated parameter Lag(k−i) instead of the current parameter Lag(k).

All received parameters that are detected as being uncorrupted are used for further processing such as the speech decoding step 46. They are also stored for the statistics in the comparison step 43.

The drawings and their description hereinbefore illustrate rather than limit the invention. It will be evident that there are numerous alternatives which fall within the scope of the appended claims. In this respect, the following closing remarks are made.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that a function is carried out by an assembly of items of hardware or software, or both.

Any reference sign in a claim should not be construed as limiting the claim. Use of the verb “to comprise” and its conjugations does not exclude the presence of elements or steps other than those stated in a claim. Use of article “a” or “an” preceding an element or step does not exclude the presence of a plurality of such elements or steps.

1. A method of processing an encoded speech signal comprising speech parameters (LTP Lag), the method comprising an error detection step (43) of detecting probably corrupted speech parameters, wherein the error detection step comprises a classification step (42) of assigning the speech parameters to at least a parameter-value range, denoted area (Area_s), among a plurality of parameter-value ranges, and of performing the error detection on the basis of statistics on speech parameters which have been previously assigned to the same area.

2. A method as claimed in claim 1, wherein the speech signal has a quasi-periodic pitch, the speech parameters representing the pitch period of the speech signal (LTP Lag).

3. A method as claimed in any one of claim 1 or 2, wherein the speech parameters (LTP Lag) are processed subsequently, the speech parameter under processing being denoted the current parameter (Lag(k)), and wherein said classification step comprises a border value calculation step (42) of calculating an average value of speech parameters which determines a border value between a lower and a higher area and of supplying an area indicator indicating to which area the current parameter belongs.

4. A method as claimed in claim 3, wherein the error detection step comprises a comparison step (43) of comparing the current parameter value with a function of at least one previous speech parameter belonging to the same area as the area indicated by the area indicator and detected as being uncorrupted, and of supplying a corruption indicator indicating if the current parameter is to be considered as being corrupted.

5. A computer program product for a receiver comprising a set of instructions which, when loaded in the receiver, causes said receiver to carry out a method as claimed in any of claim 1 to 6.

6. A receiver for receiving an encoded speech signal comprising speech parameters, the receiver comprising an error detection device (17; 22, 23) for detecting corrupted speech parameters, wherein the error detection device comprises a classification unit (22) for assigning the speech parameters to at least a parameter-value range, denoted area (Area_s), among a plurality of parameter-value ranges, and for performing the error detection on the basis of statistics on speech parameters which have been previously assigned to the same area.

7. A receiver as claimed in claim 6, wherein the classification unit comprises a calculation unit (22) for calculating an average value of received speech parameters which determines a border value between a lower and a higher area, in order to supply an area indicator (“Area_s”) for indicating to which area the speech parameters belong.

8. A receiver as claimed in claim 6, wherein the error detection device comprises a statistic unit (23) for comparing the currently received speech parameter value with a function of at least one previously received parameter belonging to the area indicated by the area indicator (“Area_s”) and previously detected as being uncorrupted, in order to supply a corruption indicator indicating if the currently received speech parameter s is probably corrupted.

9. A receiver as claimed in claim 8, comprising an error correction device including a processing unit (24;25) for receiving the area and corruption indicators from the error detection device (22;23) and for deciding if the currently received speech parameter may be corrupted and for replacing said probably corrupted speech parameter by a value depending on at least one previously received speech parameter which belongs to the same area and which was detected uncorrupted.

10. A radio telephone for receiving encoded speech signals comprising speech parameters, characterized in that it comprises a receiver as claimed in any one of claims 7 to 9.
